(19) United States
(12) Patent Application Publication
(10) Pub. No.: US 2025/0065547 A1
(43) Pub. Date: Feb. 27, 2025

(54) INJECTION MOLDING MACHINE SYSTEM, MOLD, AND METHOD FOR MOLDING MOLDED ARTICLE

(71) Applicant: THE JAPAN STEEL WORKS, LTD., Shinagawa-ku, Tokyo (JP)

(72) Inventors: Kiyotaka NAKAYAMA, Tokyo (JP); Akihiro NAITO, Tokyo (JP); Takashi UEMURA, Tokyo (JP); Keigo SUSA, Tokyo (JP); Koji MATSUZAKI, Tokyo (JP); Ryuki SAKAMOTO, Tokyo (JP); Shoso NISHIDA, Hiroshima (JP)

(21) Appl. No.: 18/726,784

(22) PCT Filed: Dec. 21, 2022
(86) PCT No.: PCT/JP2022/047249

§ 371 Date: Jul. 3, 2024

(30) Foreign Application Priority Data
Jan. 6, 2022 (JP) 2022-001178

(51) Int. Cl. B29C 45/00

(52) U.S. Cl. CPC B29C 45/006; B29C 2045/0074

(57) ABSTRACT

An injection molding machine system includes an injection molding machine, a mold, a heating heater device, and a pressing device. When the mold is closed or clamped, two or more primary molding cavities and one or more secondary molding cavities are formed. Primary molded articles are molded through injection molding when injected into the primary molding cavities. The pair of primary molded articles are placed in the secondary molding cavity, bonding end surfaces are melted by the heating heater device, and the mold is closed or clamped. When the pair of primary molded articles are pressed together by the pressing device, the primary molded articles are fused to each other to form a molded article.

### TECHNICAL FIELD

The present invention relates to an injection molding machine system in which two or more primary molded articles are molded by injection molding, the primary molded articles are paired, and bonding end surfaces of the primary molded articles are melted and fused to mold a molded article, a mold, and a molding method for a molded article.

### BACKGROUND ART

A pair of primary molded articles each having a bonding end surface are molded by injection molding. Then, the bonding end surfaces of the pair of primary molded articles are melted, and the bonding end surfaces are fused together to obtain one molded article. Patent Literature 1 describes an injection molding machine system that implements such a manufacturing method for a molded article.

### CITATION LIST

### Patent Literature

Patent Literature 1: JP2019-155775A

The injection molding machine system described in Patent Literature 1 includes a so-called opposed double-head injection molding machine and a heater implemented by a halogen heater or a carbon heater. The opposed double-head injection molding machine includes a mold clamping device and two injection devices. The mold clamping device includes a fixed platen that is fixed to a bed, a movable platen that slides along the bed, and an intermediate platen that is rotatably provided between the fixed platen and the movable platen and slides along the bed. The fixed platen, the intermediate platen, and the movable platen are each provided with a mold. When the molds are clamped, the mold of the fixed platen and the mold of the intermediate platen are clamped, and the mold of the intermediate platen and the mold of the movable platen are clamped. That is, when the plurality of molds are clamped, cavities are formed at parting lines on two sides. When resin is injected from injection devices provided on the fixed platen and the movable platen, respectively, one primary molded article is molded between the fixed platen and the intermediate platen, and one primary molded article is molded between the movable platen and the intermediate platen.

The molds are opened. Thus, the molds are opened with one primary molded article remaining in the mold of the fixed platen and the other primary molded article remaining in the mold of the intermediate platen. The intermediate platen is rotated. That is, the intermediate platen is reversed. Thus, the two primary molded articles face each other. An amount of mold opening between the fixed platen and the intermediate platen is made small, and a heater is inserted between the two primary molded articles in a non-contact manner to heat the primary molded articles. The two primary molded articles each have a bonding end surface formed thereon, and these bonding end surfaces are melted. The heater is retracted, and the fixed platen and the intermediate platen are clamped. In this way, the two primary molded articles are fused together at the bonding end surfaces to obtain a molded article.

### SUMMARY OF INVENTION

### Technical Problem

The injection molding machine system described in Patent Literature 1 is excellent in molding a molded article efficiently. However, in order to reliably fuse two primary molded articles together by clamping the molds, high dimensional accuracy is required for the primary molded articles. This is because if the dimensions of the two primary molded articles are smaller than an allowable range, fusion will be insufficient even though the molds are clamped. Further, in a case where the dimensions of the two primary molded articles are larger than the allowable range, when the molds are mold clamped after the bonding end surfaces of the two primary molded articles are melted, there is a possibility that a part of the molten resin may leak to a parting line of the mold and damages the mold.

In view of the above problems, it is an object of the present disclosure to provide an injection molding machine system, a mold, and a molding method for a molded article that can reliably fuse a pair of primary molded articles together when molding a molded article, without risking damage to a mold.

Other problems and novel features will become apparent from description of the present description and the accompanying drawings.

### Solution to Problem

The present inventors have found that the above problem can be solved by configuring an injection molding machine system as follows. That is, the present disclosure relates to an injection molding machine system including an injection molding machine, a mold, heating means, and pressing means. When the mold is closed or clamped, at least two or more primary molding cavities and at least one or more secondary molding cavities are formed. When injected into the primary molding cavities, two or more primary molded articles each having a bonding end surface are molded by injection molding. A pair of primary molded articles are inserted in the secondary molding cavity, the bonding end surfaces are melted by the heating means, and the mold is closed or clamped. Then, when the pair of primary molded articles having molten bonding end surface are pressed against each other by the pressing means, the pair of primary molded articles are fused together to form a molded article.

### Advantageous Effects of Invention

It is possible to provide an injection molding machine system in which a pair of primary molded articles are pressed against each other by the pressing means, so that an allowable range for dimensions of a primary molded article and a mold is increased, a pair of primary molded articles can be reliably fused to obtain a molded article, and there is no risk of damaging the mold.

### BRIEF DESCRIPTION OF DRAWINGS

FIG. 1 is a top view showing an injection molding machine system according to a first embodiment.

FIG. 2 is a front view showing a part of an injection molding machine, a mold, and pressing means according to the first embodiment.

FIG. 3A is a front cross-sectional view showing a part of the injection molding machine, the mold, and the pressing means, which are performing a molding method for a molded article according to the first embodiment.

FIG. 3B is a front cross-sectional view showing a part of the injection molding machine, the mold, and the pressing means, which are performing the molding method for a molded article according to the first embodiment.

FIG. 3C is a front cross-sectional view showing a part of the injection molding machine, the mold, and the pressing means, which are performing the molding method for a molded article according to the first embodiment.

FIG. 3D is a front cross-sectional view showing a part of the injection molding machine, the mold, and the pressing means, which are performing the molding method for a molded article according to the first embodiment.

FIG. 3E is a front cross-sectional view showing a part of the injection molding machine, the mold, and the pressing means, which are performing the molding method for a molded article according to the first embodiment.

FIG. 3F is a front cross-sectional view showing a part of the injection molding machine, the mold, and the pressing means, which are performing the molding method for a molded article according to the first embodiment.

FIG. 3G is a front cross-sectional view showing a part of the injection molding machine, the mold, and the pressing means, which are performing the molding method for a molded article according to the first embodiment.

FIG. 4 is a flowchart showing the molding method for a molded article according to the first embodiment.

FIG. 5A is a front cross-sectional view showing a part of an injection molding machine, a mold, and a pressing means, which are performing a molding method for a molded article according to a second embodiment.

FIG. 5B is a front cross-sectional view showing a part of the injection molding machine, the mold, and the pressing means, which are performing the molding method for a molded article according to the second embodiment.

FIG. 6 is a top view showing an injection molding machine system according to a third embodiment.

FIG. 7 is a front cross-sectional view showing a part of an injection molding machine, a mold, and pressing means according to the third embodiment.

FIG. 8 is a top view showing an injection molding machine system according to a fourth embodiment.

FIG. 9 is a front cross-sectional view showing a part of an injection molding machine, a mold, and pressing means according to the fourth embodiment.

FIG. 10 is a front cross-sectional view showing a part of an injection molding machine, a mold, and pressing means according to a fifth embodiment.

FIG. 11 is a front cross-sectional view showing a part of an injection molding machine, a mold, and pressing means according to a sixth embodiment.

### DESCRIPTION OF EMBODIMENTS

Hereinafter, specific embodiments will be described in detail with reference to the drawings. The present disclosure is not limited to the following embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

An injection molding machine system according to the present embodiment includes: an injection molding machine: a mold provided in the injection molding machine: heating means; and pressing means, in which
the mold is configured to form at least two or more primary molding cavities and at least one or more secondary molding cavities upon being closed or clamped,
each of the primary molding cavities is for molding a primary molded article having a bonding end surface by injection molding,
the secondary molding cavity is for molding a molded article from a pair of the primary molded articles taken out from the primary molding cavities by placing the pair of primary molded articles in the secondary molding cavity and closing or clamping the mold,
the heating means is configured to melt the bonding end surfaces of the pair of primary molded articles place in the secondary molding cavity, and
the pressing means is configured to press the pair of primary molded articles with molten bonding end surfaces against each other in a state where the mold is closed or clamped such that the pair of primary molded articles are fused together to obtain a molded article.

A mold according to the present embodiment includes: at least two or more primary molding cavities and at least one or more secondary molding cavities when the mold is closed or clamped, in which
the primary molding cavity is configured to mold a primary molded article by injection molding, and
the secondary molding cavity is provided with a slide core to be driven in a direction perpendicular to a parting line and is configured to receive a pair of the primary molded articles taken out from the primary molding cavities.

A molding method for a molded article according to the present embodiment is a molding method for molding a molded article in an injection molding machine system,
the injection molding machine system including an injection molding machine, a mold provided in the injection molding machine, heating means, and pressing means, in which the mold is configured to form at least two or more primary molding cavities and at least one or more secondary molding cavities upon being closed or clamped,
the molding method including:
an injection molding step including molding two or more primary molded articles each having a bonding end surface by clamping the mold and injecting an injection material into the two or more primary molding cavities:
a mold opening step of opening the mold;
a conveying step including taking out the primary molded articles from the two or more primary molding cavities and inserting the pair of primary molded articles into the secondary molding cavity:
a melting step including inserting the heating means between the bonding end surfaces of the pair of primary molded articles inserted into the secondary molding cavity to melt the bonding end surfaces; and
a press-fusion step including retracting the heating means, closing or clamping the mold, and using the pressing means to press and fuse the pair of primary molded articles having the molten bonding end surfaces against each other in the secondary molding cavity to obtain a molded article.

### First Embodiment

### <Injection Molding Machine System>

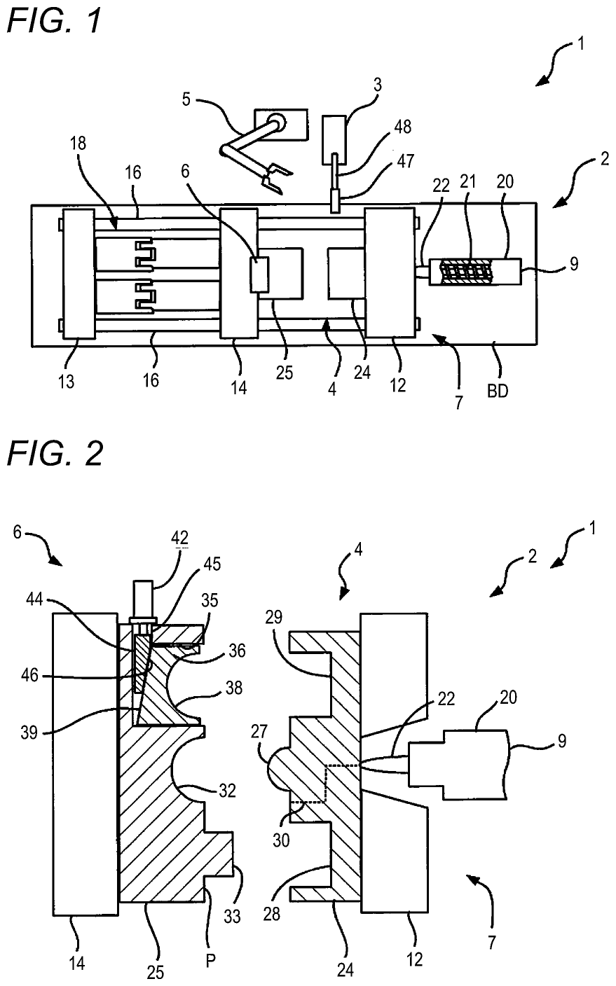

As shown in FIG. 1, an injection molding machine system 1 according to a first embodiment includes an injection molding machine 2, a heater device 3 serving as heating means provided adjacent to the injection molding machine 2, and a conveying device 5 similarly provided adjacent to the injection molding machine 2. The injection molding machine 2 is provided with a mold 4, and pressing means 6 is provided in association with the mold 4.

### <Injection Molding Machine>

The injection molding machine 2 according to the first embodiment includes a mold clamping device 7 and an injection device 9 provided on a bed BD.

### <Mold Clamping Device>

The mold clamping device 7 includes a fixed platen 12 fixed on the bed BD, a mold clamping housing 13 slidably provided on the bed BD, and a movable platen 14 slidably provided on the bed BD between the fixed platen 12 and the mold clamping housing 13. The fixed platen 12 and the mold clamping housing 13 are coupled by a plurality of tie bars 16, 16, . . . , and the tie bars 16, 16, . . . penetrate the movable platen 14. A toggle mechanism 18 serving as a mold clamping mechanism is provided between the mold clamping housing 13 and the movable platen 14. Accordingly, when the toggle mechanism 18 is driven, the movable platen 14 is driven. Note that another mechanism such as a mold clamping cylinder may be adopted as the mold clamping mechanism.

### <Injection Device>

The injection device 9 includes a heating cylinder 20 and a screw 21 placed in the heating cylinder 20. An injection nozzle 22 is provided at a tip end of the heating cylinder 20, and to come into contact with the mold 4 to be described in detail below with a predetermined touch force.

### <Mold>

As shown in FIG. 2, the mold 4 according to the first embodiment includes a first mold 24 provided on the fixed platen 12 and a second mold 25 provided on the movable platen 14. The first mold 24 has a first protruding portion 27, a first recessed portion 28, and a second recessed portion 29 formed therein. The first mold 24 is provided with a runner 30 through which an injection material injected from the injection device 9 flows. The second mold 25 has a third recessed portion 32 and a second protruding portion 33 formed therein. As described later, when the mold 4 is closed or clamped, the first protruding portion 27 and the third recessed portion 32 form a primary molding cavity, and the first recessed portion 28 and the second protruding portion 33 form a primary molding cavity. The injection material may be, for example, resin.

The second mold 25 is provided with a characteristic structure in the present embodiment at a position facing the second recessed portion 29 of the first mold 24. That is, a core storage hole 35 is formed in the second mold 25, and a slide core 36 is slidably stored in the core storage hole 35. A fourth recessed portion 38 is formed in the slide core 36. Therefore, as described later, when the mold 4 is closed or clamped, the second recessed portion 29 and the fourth recessed portion 38 form a secondary molding cavity. The slide core 36 has a tapered surface 39 formed on a back surface side. The tapered surface 39 is pressed by the pressing means 6 described below, and the slide core 36 is driven.

### <Pressing Means>

In the first embodiment, the pressing means 6 includes a hydraulic cylinder 42 provided in the second mold 25 and a slide member 44 driven by the hydraulic cylinder 42. The slide member 44 is inserted into the second mold 25. That is, the second mold 25 has an insertion opening 45 communicating with the core storage hole 35, and the slide member 44 is inserted through the insertion opening 45 with a part reaching the core storage hole 35. The slide member 44 is formed with a tapered surface 46, and the tapered surface 46 is in sliding contact with the tapered surface 39 of the slide core 36. The slide member 44 is driven by the hydraulic cylinder 42 and slides parallel to a parting line P. When the slide member 44 is driven, action of the tapered surfaces 39, 46 causes the slide core 36 to be driven in a direction perpendicular to the parting line P.

As described above, it is preferable that the secondary molding cavity is provided with the slide core, and that the slide core is driven by the pressing means in the direction perpendicular to the parting line of the mold.

Further, it is preferable that the pressing means includes a slide member that slides parallel to the parting line of the mold, a back surface of the slide core and a front surface of the slide member are respectively formed into tapered surfaces, and the tapered surfaces are in sliding contact with each other.

### <Heater Device>

As shown in FIG. 1, the heater device 3 according to the first embodiment is provided in the vicinity of the fixed platen 12. The heater device 3 includes a heater 47 and a drive unit 48 that drives the heater 47 to slide back and forth. The heater 47 is a carbon heater or a halogen heater. The heater 47 is supplied with an electric current from a power supply unit (not shown), and reaches a temperature of 1000° C. or higher within a few seconds after being energized. Accordingly, resin in the vicinity can be melted in a short time in a non-contact manner. That is, the heater device 3 according to the present embodiment is not only simple heating means but also non-contact heating means. As described above, it is preferable that the heating means includes a heater which emits infrared rays to melt the bonding end surfaces in a non-contact manner.

### <Conveying Device>

In the first embodiment, as shown in FIG. 1, the conveying device 5 is made up of a robot arm. As described later, the conveying device serves as conveying means configured to take out an injection-molded primary molded article from the primary molding cavity and convey the primary molded article to the secondary molding cavity.

That is, it is preferable that the injection molding machine system includes conveying means, and the conveying means is configured to convey the primary molded article molded in the primary molding cavity to the secondary molding cavity.

### <Molding Method for Molded Article>

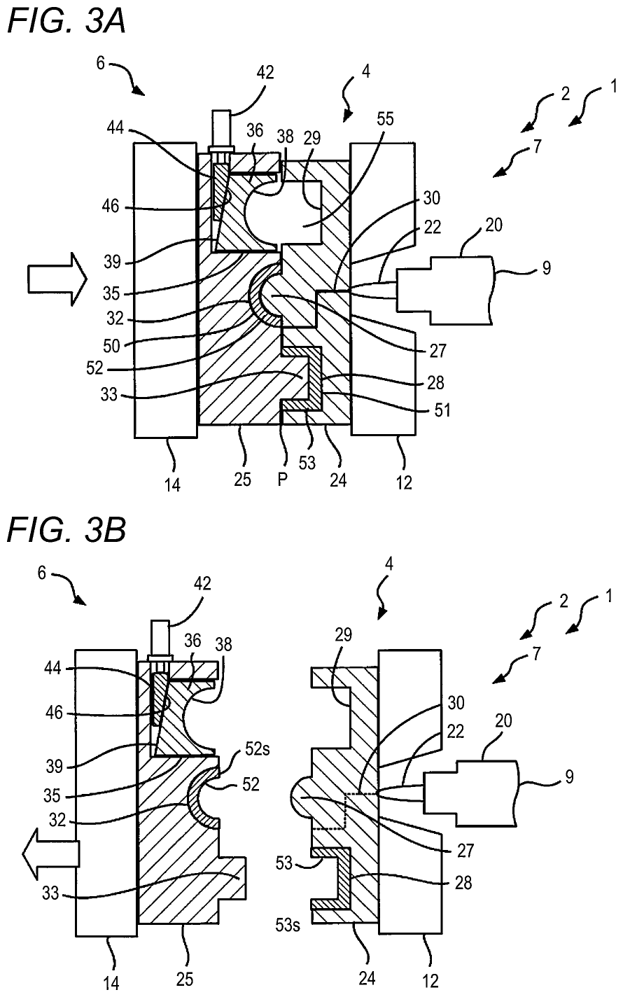

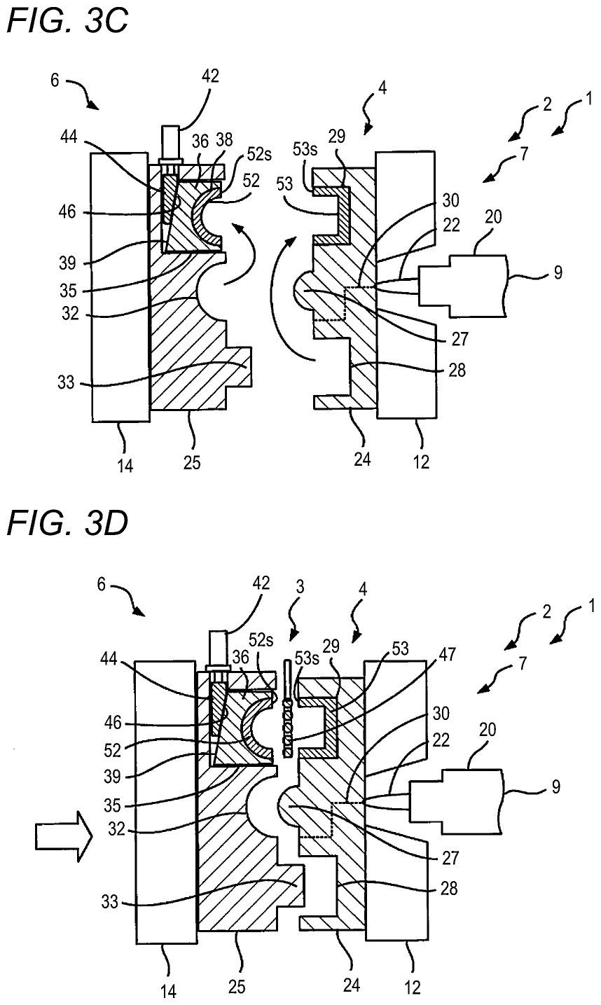

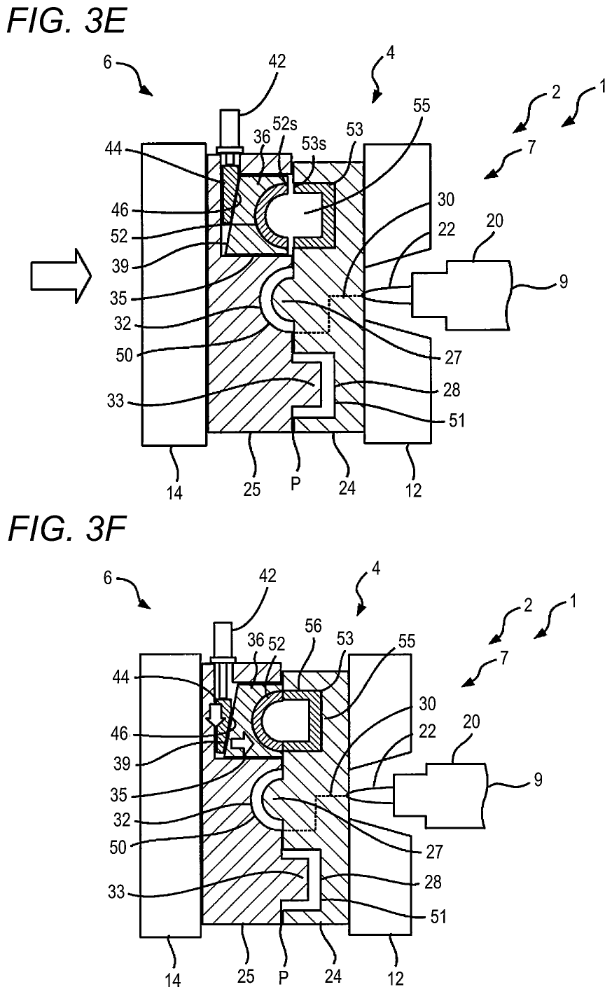

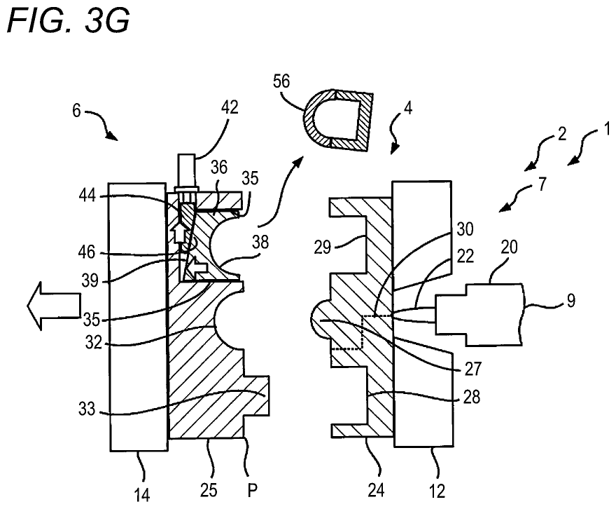

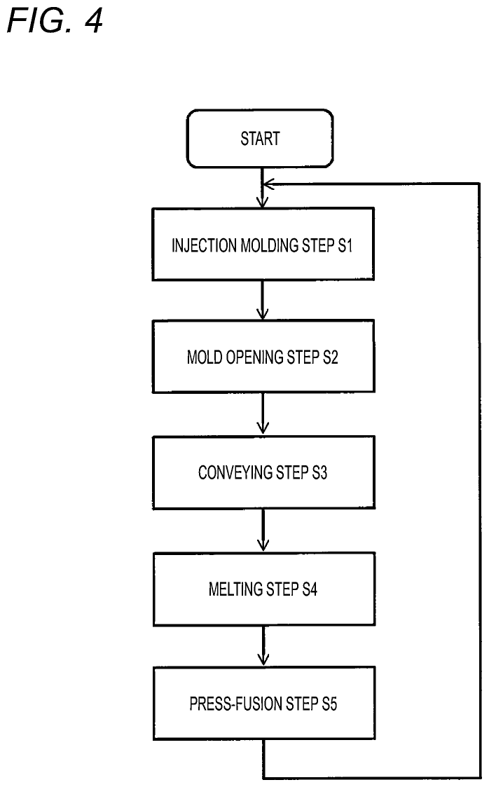

A molding method for molding a molded article using the injection molding machine system 1 (see FIGS. 1 and 2) will be described. First, as shown in FIG. 4, an injection molding step S1 is performed. In the injection molding machine 2, the mold clamping device 7 is driven to clamp the mold 4. When the mold is clamped, as shown in FIG. 3A, the first protruding portion 27 and the third recessed portion 32 form a first primary molding cavity 50, and the first recessed portion 28 and the second protruding portion 33 form a second primary molding cavity 51. The injection material is injected from the injection device 9 to fill the first and second primary molding cavities 50 and 51, and a first primary molded article 52 and a second primary molded article 53, that is, a pair of primary molded articles 52 and 53 are molded.

After the pair of primary molded articles 52 and 53 are cooled and solidified, a mold opening step S2 is performed as shown in FIG. 4. That is, the mold clamping device 7 is driven to open the mold 4. As shown in FIG. 3B, the first primary molded article 52 remains in the third recessed portion 32 of the second mold 25, and the second primary molded article 53 remains in the first recessed portion 28 of the first mold 24. The first and second primary molded articles 52 and 53 have bonding end surfaces 52s and 53s, respectively.

Then, as shown in FIG. 4, a conveying step S3 is performed. That is, by the conveying device 5 (see FIG. 1), the first primary molded article 52 is taken out from the third recessed portion 32 and inserted into the fourth recessed portion 38 of the slide core 36, and the second primary molded article 53 is taken out from the first recessed portion 28 and inserted into the second recessed portion 29. FIG. 3C shows a state in which the pair of primary molded articles 52 and 53 are inserted into the fourth recessed portion 38 and the second recessed portion 29. The pair of primary molded articles 52 and 53 are in a state where the bonding end surfaces 52s and 53s face each other.

As shown in FIG. 4, a melting step S4 is performed. First, the mold clamping device 7 (see FIG. 1) is driven to bring the bonding end surfaces 52s and 53s of the pair of primary molded articles 52 and 53 close to each other as shown in FIG. 3D. The heater device 3 is driven to insert the heater 47 between the bonding end surfaces 52s and 53s in a non-contact manner. The heater 47 is energized to melt the bonding end surfaces 52s and 53s in a non-contact manner. Alternatively, the heater device 3 may be first driven to be positioned between the bonding end surfaces 52s and 53s, and then the mold clamping device 7 may be driven to bring the bonding end surfaces 52s and 53s close to the heater 47. When the bonding end surfaces 52s and 53s are melted by the heater 47, the heater device 3 is driven to retract the heater 47.

As shown in FIG. 4, a press-fusion step S5 is performed. That is, the mold clamping device 7 is driven to close the mold 4. Alternatively, the mold is clamped. Then, as shown in FIG. 3E, a cavity is formed by the fourth recessed portion 38 of the slide core 36 in which the first primary molded article 52 is inserted and the second recessed portion 29 in which the second primary molded article 53 is inserted. That is, a secondary molding cavity 55 is formed. At this time, the bonding end surfaces 52s and 53s of the pair of primary molded articles 52 and 53 are slightly spaced apart from each other. Since the bonding end surfaces 52s and 53s are spaced apart from each other, the resin is not pushed out laterally from the molten bonding end surfaces 52s and 53s and does not leak out to the parting line P.

As shown in FIG. 3F, the pressing means 6 is driven. That is, the hydraulic cylinder 42 is driven to slide the slide member 44 downward. Thus, the slide core 36 is driven in a direction perpendicular to the parting line P by the action of the tapered surfaces 39 and 46. Accordingly, the pair of primary molded articles 52 and 53 are pressed against each other, and the bonding end surfaces 52s and 53s are fused together. A molded article 56 is molded. By being pressed by the pressing means 6, the pair of primary molded articles 52 and 53 can be reliably fused together. That is, the dimensional accuracy required for the primary molded articles 52 and 53 is relatively lenient, and the primary molded articles 52 and 53 can be molded stably.

When the mold clamping device 7 is driven to open the mold 4, the molded article 56 is obtained as shown in FIG. 3G. At this time, the hydraulic cylinder 42 of the pressing means 6 is driven to slide the slide member 44 upward. Although not shown, the slide core 36 is provided with, for example, a spring or the like, and is biased toward the back of the core storage hole 35. When the slide member 44 slides upward, the slide core 36 slides to the back of the core storage hole 35. That is, it prepares for the next molding cycle. Thereafter, the molding cycle is repeated in the same manner.

It is preferable that the injection molding machine system includes a control unit, the control unit being configured to perform:
an injection molding step including molding the primary molded article by clamping the mold and injecting into the primary molding cavity:
a melting step including opening the mold and taking out the pair of the primary molded articles, inserting the pair of primary molded articles into the secondary molding cavity, and melting the bonding end surfaces by the heating means, and
a press-fusion step including closing or clamping the mold, and pressing the pair of primary molded articles against each other by the pressing means to fuse the pair of primary molded articles together, resulting in the molded article.

### Second Embodiment

### <Injection Molding Machine System>

The configuration of AN injection molding machine system according to the second embodiment is the same as the configuration of the injection molding machine system 1 according to the first embodiment.

### <Molding Method for Molded Article>

A molding method for a molded article according to the second embodiment is a modification of the molding method for a molded article according to the first embodiment. To put it simply, in the flowchart of FIG. 4, when the press-fusion step S5 is being performed, the injection molding step S1 of a next molding cycle is performed substantially simultaneously to obtain a molded article efficiently in the molding method.

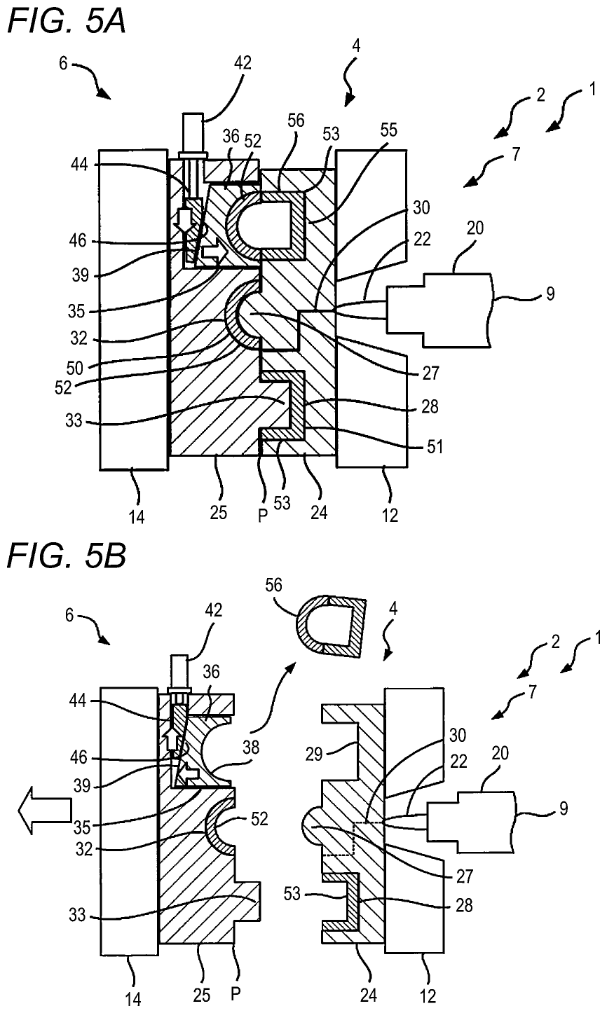

First, as in the molding method for a molded article according to the first embodiment, as shown in FIGS. 3A to 3D, the injection molding step S1, the mold opening step S2, the conveying step S3, and the melting step S4 are sequentially performed. Then, as shown in FIG. 5A, the press-fusion step S5 and the next injection molding step S1 are performed in parallel. In the manufacturing method for a molded article according to the first embodiment, when the secondary molding cavity 55 is formed by the fourth recessed portion 38 and the second recessed portion 29, the mold 4 may be closed instead of clamped. However, in the molding method for a molded article according to the second embodiment, the mold 4 is clamped to generate a clamping force. This is in preparation for the injection molding step S1. The pressing means 6 presses the pair of primary molded articles 52 and 53 to form the molded article 56. In parallel, the injection material is injected from the injection device 9 to fill the first and second primary molding cavities 50 and 51, and the first and second primary molded articles 52 and 53 are molded.

After the molded article 56 is obtained, as shown in FIG. 5B, the mold clamping device 7 is driven to open the mold 4 to take out the molded article 56. The first primary molded article 52 molded by injection molding remains in the third recessed portion 32 of the second mold 25, and the second primary molded article 53 remains in the first recessed portion 28 of the first mold 24. As described in the first embodiment, the conveying step S3 and the melting step S4 (see FIG. 4) are performed. Thereafter, molding is performed in the same manner. In the second embodiment, the molded article 56 can be obtained each time the mold 4 is clamped, resulting in high efficiency.

As described above, it is preferable that the control unit of the injection molding machine system performs the injection molding step and the press-fusion step in parallel and substantially simultaneously, and when a molded article is obtained, a pair of primary molded articles to be fused together next time are molded.

### Third Embodiment

### <Injection Molding Machine System>

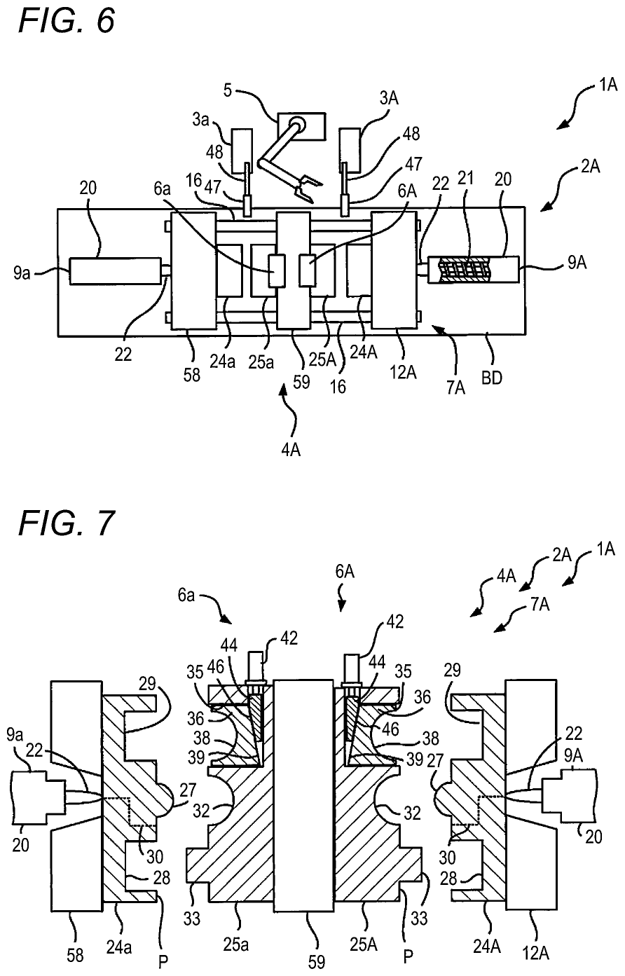

An injection molding machine system 1A according to a third embodiment is shown in FIG. 6. The injection molding machine system 1A according to the third embodiment includes a so-called double-head injection molding machine 2A, two heater devices 3A and 3a, the conveying device 5, a mold 4A provided in the injection molding machine 2A, and two pressing means 6A and 6a.

### <Injection Molding Machine>

The injection molding machine 2A according to the third embodiment includes a mold clamping device 7A and two injection devices 9A and 9a provided on the bed BD. The mold clamping device 7A includes three mold platens. That is, the mold clamping device 7C includes a fixed platen 12A that is fixed to the bed BD, a movable platen 58 that is slidable on the bed BD, and an intermediate platen 59 that is provided between the fixed platen 12A and the movable platen 58 and is slidable on the bed BD. When a mold clamping mechanism (not shown) is driven, the fixed platen 12A, the intermediate platen 59, and the movable platen 58 are clamped together. One of the two injection devices 9A and 9a is provided on the fixed platen 12A, and the other is provided on the movable platen 58, and THE injection material is injected from both of the two injection devices 9A and 9a.

### <Mold>

As shown in FIGS. 6 and 7, the injection molding machine 2A according to the third embodiment is provided with four molds 4A. Specifically, two sets of molds having the same structure as the mold 4 including the first mold 24 and the second mold 25 as described in the first embodiment in FIG. 2 are provided. That is, as shown in FIG. 7, the first set of molds include a first mold 24A provided on the fixed platen 12A and a second mold 25A provided on the intermediate platen 59. The second set of molds include a first mold 24a provided on the movable platen 58 and a second mold 25a provided on the intermediate platen 59. That is, in the third embodiment, the mold 4A includes four molds 24A, 25A, 24a, and 25a. Therefore, when the mold is closed or clamped, parting lines P and P are formed on two surfaces, and two primary molding cavities and one secondary molding cavity are formed in each of the parting lines P and P.

In the third embodiment, two sets of first molds 24A and 24a and second molds 25A and 25a are provided, and when the mold clamping device 7A is used for clamping, clamping forces can be applied simultaneously, which is efficient. Further, injection molding can be performed by the two injection devices 9A and 9a, and the two heater devices 3A and 3a and the two pressing means 6A and 6a are provided, so that a molded article can be molded efficiently. Although the description has been given of one conveying device 5 as shown in FIG. 6, two conveying devices may be provided.

As described above, the injection molding machine may include a plurality of mold platens that are clamped together, the molds are provided on the plurality of the mold platens and have parting lines on a plurality of surfaces, and when the molds are closed or clamped, two or more of the primary molding cavities and one or more of the secondary molding cavities may be formed at each of the parting lines on the plurality of surfaces.

### Fourth Embodiment

### <Injection Molding Machine System>

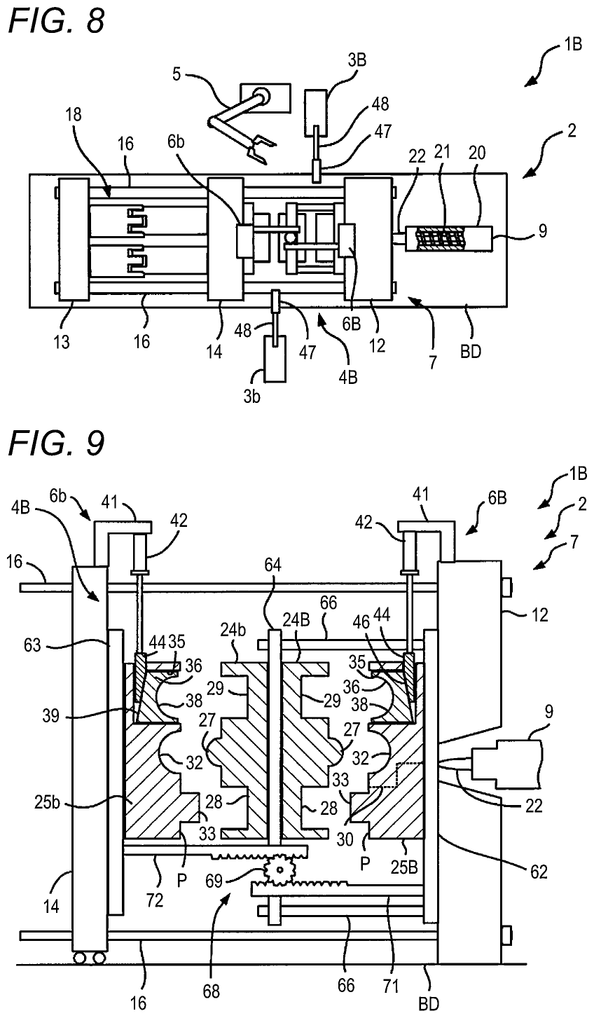

FIG. 8 shows an injection molding machine system 1B according to a fourth embodiment. The injection molding machine 2 of the injection molding machine system 1B has the same configuration as the injection molding machine 2 in the first embodiment. A mold 4B provided in the injection molding machine 2 is a so-called stack mold, and includes two parting lines P and P on two surfaces as described below. The fixed platen 12 and the movable platen 14 are provided with pressing means 6B and 6b respectively, so as to correspond to the mold 4B. That is, two pressing means 6B and 6b are provided. The injection molding machine system 1B according to the fourth embodiment includes two heater devices 3B and 3b.

### <Mold>

The mold 4B according to the fourth embodiment is shown in FIG. 9. The mold 4B includes a fixed side attachment plate 62 attached to the fixed platen 12, a movable side attachment plate 63 attached to the movable platen 14, and an intermediate plate 64. In the fourth embodiment, the mold 4B has a configuration in which two sets of molds having the same structure as the mold 4 including the first mold 24 and the second mold 25 as described in the first embodiment in FIG. 2 are provided. That is, the first mold 24B and the second mold 25B, which correspond to the first set of molds, are provided on the intermediate plate 64 and the fixed side attachment plate 62, respectively. The first mold 24b and the second mold 25b, which correspond to the second set of molds, are provided on the intermediate plate 64 and the movable side attachment plate 63, respectively.

The fixed side attachment plate 62 is provided with a plurality of guide rods 66 and 66, and the intermediate plate 64 is provided so as to be slidable by the guide rods 66 and 66. That is, the intermediate plate 64 slides in directions toward and away from the fixed side attachment plate 62.

The mold 4B includes a rack-pinion mechanism 68. The rack-pinion mechanism 68 includes a pinion 69 rotatably provided on the intermediate plate 64, a first rack 71 fixed to the fixed side attachment plate 62, and a second rack 72 fixed to the movable side attachment plate 63. The first rack 71 and second rack 72 are engaged with the pinion 69. Accordingly, when the movable platen 14 is driven and the movable side attachment plate 63 slides, the intermediate plate 64 slides in conjunction. That is, the two sets of first and second molds 24B, 24b, 25B, and 25b are simultaneously opened and closed. That is, the mold 4B has two parting lines P and P which are simultaneously clamped.

In this embodiment, the hydraulic cylinders 42 and 42 of the pressing means 6B and 6b are provided on the fixed platen 12 and the movable platen 14 instead of the second molds 25B and 25b. That is, the fixed platen 12 and the movable platen 14 are provided with brackets 41 and 41, respectively, and the brackets 41 and 41 are provided with hydraulic cylinders 42 and 42, respectively. These hydraulic cylinders 42 and 42 drive the slide members 44 and 44 to slide the slide cores 36 and 36 in the same manner as in the first embodiment.

Similarly to the third embodiment, the fourth embodiment also has two sets of the first molds 24B and 24b and the second molds 25B and 25b are provided, and when the mold clamping device 7 is used for clamping, clamping forces can be applied simultaneously, which is efficient. A pair of primary molded articles can be formed by injection molding at each of the parting lines P and P on the two surfaces. Since the two heater devices 3B and 3b (see FIG. 8) and the two pressing means 6B and 6b are provided, a molded article can be molded efficiently. Although the description has been given of one conveying device 5 as shown in FIG. 8, two conveying devices may be provided.

As described above, the mold is formed of a stack mold having parting lines on a plurality of surfaces, and when the molds are closed or clamped, two or more of the primary molding cavities and one or more of the secondary molding cavities may be formed at each of the parting lines on the plurality of surfaces.

### Fifth Embodiment

### <Injection Molding Machine System>

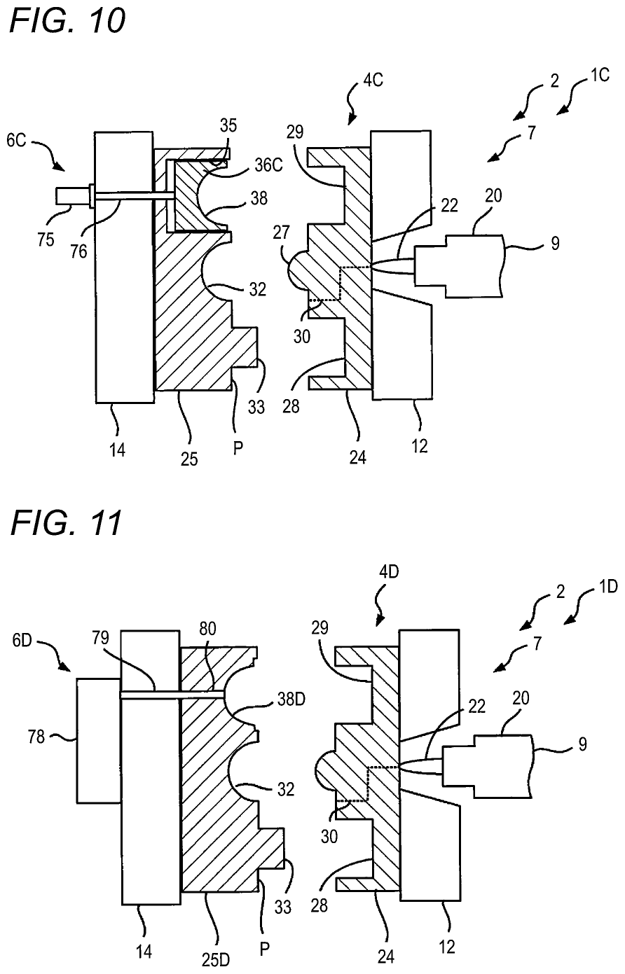

A part of an injection molding machine system 1C according to a fifth embodiment is shown in FIG. 10. In the configuration of the injection molding machine system 1C according to the fifth embodiment, pressing means 6C is modified with respect to the configuration of the injection molding machine system 1 (see FIGS. 1 and 2) according to the first embodiment. That is, the pressing means 6C includes a hydraulic cylinder 75 provided on the movable platen 14, and a piston rod 76 passes through the movable platen 14 and is connected to a slide core 36C of a mold 4C. In the fifth embodiment, the slide core 36C is directly driven by the piston rod 76, so that a back surface of the slide core 36C does not need to be formed into a tapered surface. The injection molding machine system 1C according to the fifth embodiment can also mold a molded article in the same manner as the injection molding machine system 1 according to the first embodiment.

### Sixth Embodiment

### <Injection Molding Machine System>

A part of an injection molding machine system 1D according to a sixth embodiment is shown in FIG. 11. In the configuration of the injection molding machine system 1D according to the sixth embodiment, a mold 4D and pressing means 6D are modified with respect to the configuration of the injection molding machine system 1 (see FIGS. 1 and 2) according to the first embodiment. The mold 4D includes the first mold 24 and a second mold 25D. The first mold 24 is configured similarly to the mold 4 (see FIG. 2) according to the first embodiment, but the second mold 25D is modified. Specifically, the second mold 25D is not provided with a slide core, and a fourth recessed portion 38D is formed in the second mold 25D.

In the sixth embodiment, the pressing means 6D includes an ejector rod 79 of an ejector device 78. The ejector rod 79 is inserted into a rod hole 80 formed in the second mold 25D so as to communicate with the fourth recessed portion 38D. A primary molded article placed in the fourth recessed portion 38D is directly pressed by the ejector rod 79 in the press-fusion step S5 (see FIG. 4).

### <Other Modifications>

The injection molding machine systems 1, 1A, . . . and the molding method for a molded article according to the first to sixth embodiments can be variously modified. For example, in the injection molding machine system 1A (see FIGS. 6 and 7) according to the third embodiment, four or more mold platens that are clamped together may be provided, and the parting lines P, P, . . . of the molds 4A that are clamped simultaneously may be formed on three or more surfaces. Similarly, in the injection molding machine system 1B (refer to FIGS. 8 and 9) according to the fourth embodiment, the mold 4B formed of the stack mold may be modified, and the parting lines P, P, . . . may be formed on three or more surfaces. In this manner, by increasing the number of surfaces of the parting lines P, P, . . . and molding a pair of primary molded articles and one secondary molded article at each of the parting lines P, P, . . . , the efficiency can be increased. Alternatively, in the injection molding machine system 1 (see FIGS. 1 and 2) according to the first embodiment, if the shape of the mold 4 is modified to increase the number of cavities, the number of molded articles that can be manufactured for each mold clamping can be similarly increased.

In addition, in the third embodiment, a molded article molded in the molds 24A and 25A may be different from a molded article molded in the molds 24a and 25a. In this case, two molded articles having different shapes are fused together. The first and second primary molded articles 52, 53 do not necessarily have to be molded by a single injection. For example, when the injection volumes of the first primary molded article 52 and the second secondary molded article 53 are significantly different, the injection may be divided into two times. That is, by using a hot runner valve gate system or the like, the first primary molded article 52 is molded by a first injection, and the second primary molded article 53 is molded by a second injection. By dividing the injection in this manner, molding defects such as flash and sink marks can be prevented.

The pressing means 6 may also be modified. For example, in the injection molding machine system 1C (see FIG. 10) according to the fifth embodiment, the pressing means 6C is implemented by the hydraulic cylinder 75, and the slide core 36C is driven by the piston rod 76. The pressing means 6C may be formed of an ejector rod 79 of an ejector device 78 as shown in FIG. 11. That is, the slide core 36 may be driven by the ejector rod 79. That is, the pressing means may be an ejector rod, and the slide core may be driven by the ejector rod.

The rack-pinion mechanism 68 in the fourth embodiment may also be modified. That is, the rack-pinion mechanism 68 may be replaced by another mechanism having the same function. As an example of alternative means, a link mechanism may be adopted.

The heating means may also be modified. It has been described that the heating means includes the heater 47 which performs heating with infrared rays in a non-contact manner. Alternatively, the heating means may include a heater made of a heated metal plate or the like, and perform heating by contact. In this case, the heater is brought into contact with the bonding end surfaces 52s and 53s of the primary molded articles 52 and 53 (see FIG. 3D) for direct melting.

Although the invention made by the present inventor has been specifically described above based on the embodiments, it is needless to say that the present invention is not limited to the embodiments described above, and various modifications can be made without departing from the scope of the invention. The plurality of examples described above may be appropriately combined.

### INDUSTRIAL APPLICABILITY

According to the present disclosure, it is possible to provide an injection molding machine system, a mold, and a molding method for a molded article that can reliably fuse a pair of primary molded articles together to mold a molded article, without risking damage to a mold.

Although the present invention has been described in detail with reference to specific embodiments, it will be apparent to those skilled in the art that various changes and modifications can be made without departing from the spirit and scope of the present invention.

The present application is based on Japanese Patent Application No. 2022-001178 filed on Jan. 6, 2022, and the contents thereof are incorporated herein as reference.

REFERENCE SIGNS LIST

| | |
|---|---|
| 1, 1A, 1B, 1C, 1D Injection molding machine system | |
| 2, 2A Injection molding machine | |
| 3, 3A, 3a, 3B, 3b Heater device | |
| 4 Mold | |
| 5 Conveying device | |
| 6, 6A, 6a, 6B, 6b, 6C, 6D Pressing means | |
| 7, 7A Mold clamping device | |
| 9, 9A, 9a Injection device | |
| 12, 12A Fixed platen | 13 Mold clamping housing |
| 14 Movable platen | 16 Tie bar |
| 18 Toggle mechanism | 20 Heating cylinder |
| 21 Screw | 22 Injection nozzle |
| 24, 24A, 24a, 24B, 24b First mold | |
| 25, 25A, 25a, 25B, 25b, 25D Second mold | |
| 27 First protruding portion | 28 First recessed portion |
| 29 Second recessed portion | 30 Runner |
| 32 Third recessed portion | 33 Second protruding portion |
| 35 Core storage hole | 36, 36C Slide core |
| 38, 38D Fourth recessed portion | 39 Tapered surface |
| 41 Bracket | 42 Hydraulic cylinder |
| 44 Slide member | 45 Insertion opening |
| 46 Tapered surface | 47 Heater |
| 48 Drive unit | 50 First primary molding cavity |
| 51 Second primary molding cavity | |
| 52 First primary molded article | 52s Bonding end surface |
| 53 Second primary molded article | 53s Bonding end surface |
| 55 Secondary molding cavity | 56 Molded article |
| 58 Movable platen | 59 Intermediate platen |
| 62 Fixed side attachment plate | 63 Movable side attachment plate |
| 64 Intermediate plate | 66 Guide rod |
| 68 Rack-pinion mechanism | 69 Pinion |
| 71 First rack | 72 Second rack |
| 75 Hydraulic cylinder | 76 Piston rod |
| 78 Ejector device | 79 Ejector rod |
| 80 Rod hole | |
| BD Bed | |
| P Parting line | |

What is claimed is:

1. An injection molding machine system comprising:
an injection molding machine;
a mold provided in the injection molding machine;
a heater device; and
a pressing device,
wherein the mold is configured to form at least two or more primary molding cavities and at least one or more secondary molding cavities upon being closed or clamped, wherein each of the primary molding cavities is for molding a primary molded article having a bonding end surface by injection molding,
wherein the secondary molding cavity is for molding a molded article from a pair of the primary molded articles taken out from the primary molding cavities by placing the pair of primary molded articles in the secondary molding cavity and closing or clamping the mold,
wherein the heater device is configured to melt the bonding end surfaces of the pair of primary molded articles placed in the secondary molding cavity, and
wherein the pressing device is configured to press the pair of primary molded articles with molten bonding end surfaces against each other in a state where the mold is closed or clamped such that the pair of primary molded articles are fused together to obtain a molded article.

2. The injection molding machine system according to claim 1, further comprising:
a conveying device,
wherein the conveying device is configured to convey the primary molded article molded in the primary molding cavity to the secondary molding cavity.

3. The injection molding machine system according to claim 1, wherein the heater device includes a heater configured to emit an infrared ray to melt the bonding end surface in a non-contact manner.

4. The injection molding machine system according to claim 1, wherein the secondary molding cavity includes a slide core, and the slide core is driven by the pressing device in a direction perpendicular to a parting line of the mold.

5. The injection molding machine system according to claim 4, wherein the pressing device includes a slide member configured to slide parallel to the parting line of the mold, a back surface of the slide core and a front surface of the slide member are respectively formed into tapered surfaces, and the tapered surfaces are in sliding contact with each other.

6. The injection molding machine system according to claim 4, wherein the pressing device is an ejector rod, and the slide core is driven by the ejector rod.

7. The injection molding machine system according to claim 1,
wherein the injection molding machine includes a plurality of mold platens that are clamped together, and
wherein the mold is provided on the plurality of mold platens and has parting lines on a plurality of surfaces, and when the mold is closed or clamped, two or more of the primary molding cavities and one or more of the secondary molding cavities are formed at each of the parting lines on the plurality of surfaces.

8. The injection molding machine system according to claim 1, wherein the mold is a stack mold having parting lines on a plurality of surfaces, and when the mold is closed or clamped, two or more of the primary molding cavities and one or more of the secondary molding cavities are formed at each of the parting lines on the plurality of surfaces.

9. The injection molding machine system according to claim 1, further comprising:
a control device,
wherein the control device is configured to perform:
an injection molding step comprising molding the primary molded article by clamping the mold and injecting an injection material into the primary molding cavity;
a melting step comprising opening the mold and taking out the pair of the primary molded articles, inserting the pair of primary molded articles into the secondary molding cavity, and melting the bonding end surfaces by the heater device; and
a press-fusion step comprising closing or clamping the mold, and pressing the pair of primary molded articles against each other by the pressing device to fuse the pair of primary molded articles together, resulting in the molded article.

10. The injection molding machine system according to claim 9, wherein the injection molding step and the press-fusion step are performed in parallel and substantially simultaneously, and the system is configured to mold a pair of primary molded articles for the subsequent fusing in the case of obtaining the molded article.

11. A mold comprising:
at least two or more primary molding cavities and at least one or more secondary molding cavities upon the mold being closed or clamped,
wherein each of the primary molding cavities is for molding a primary molded article by injection molding, and
wherein the secondary molding cavity includes a slide core configured to be driven in a direction perpendicular to a parting line and is configured to receive a pair of the primary molded articles taken out from the primary molding cavities.

12. A molding method for molding a molded article in an injection molding machine system,
the injection molding machine system including:
an injection molding machine;
a mold provided in the injection molding machine;
a heater device; and
a blessing device,
the mold being configured to form at least two or more primary molding cavities and at least one or more secondary molding cavities upon being closed or clamped, the molding method comprising:
an injection molding step comprising molding two or more primary molded articles each having a bonding end surface by clamping the mold and injecting an injection material into the two or more primary molding cavities;
a mold opening step of opening the mold;
a conveying step comprising taking out the primary molded articles from the two or more primary molding cavities and inserting the pair of primary molded articles into the secondary molding cavity;
a melting step comprising inserting the heater device between the bonding end surfaces of the pair of primary molded articles inserted into the secondary molding cavity to melt the bonding end surfaces; and
a press-fusion step comprising retracting the heater device, closing or clamping the mold, and using the pressing device to press and fuse the pair of primary molded articles having the molten bonding end surfaces against each other in the secondary molding cavity to obtain a molded article.
